(19) United States
(12) Patent Application Publication
(10) Pub. No.: US 2025/0062443 A1
(43) Pub. Date: Feb. 20, 2025

(54) BATTERY IMMERSION COOLING WITH CONTROLLABLE DIELECTRIC BOILING POINT AND THERMAL RUNWAY PASSIVE PROTECTION

(71) Applicant: Blue Origin Alabama, LLC, Huntsville, AL (US)

(72) Inventors: Mitch Mabrey, Grandview, MO (US); Daniele Suzzi, Grandview, MO (US)

(21) Appl. No.: 18/859,724

(22) PCT Filed: Apr. 26, 2023
(86) PCT No.: PCT/US2023/066233

§ 371 Date: Oct. 24, 2024

Related U.S. Application Data
(60) Provisional application No. 63/334,848, filed on Apr. 26, 2022.

(51) Int. Cl. H01M 10/6569; H01M 10/613; H01M 10/6568; H01M 50/204

(52) U.S. Cl. CPC H01M 10/6569; H01M 10/613; H01M 10/6568; H01M 50/204

(57) ABSTRACT

The present invention relates to battery immersion cooling of battery cells through vaporization of a dielectric liquid, such as through nucleate boiling. The boiling point of the liquid can be adjusted through control of the pressure to which the dielectric liquid is exposed. The quantity of liquid dielectric material is selected to adsorb the complete reaction energy of the electrical parallel cells in case of thermal runaway, leading to no propagation, flame or explosion.

### CROSS-REFERENCE TO RELATED APPLICATION

This application claims the benefit of U.S. Provisional Patent Application No. 63/334,848, filed Apr. 26, 2022, which is incorporated by reference herein in its entirety.

### BACKGROUND OF THE INVENTION

### Field of the Invention

The present invention relates to battery immersion cooling of Lithium-ion battery cells. More particularly, aspects of the invention relate to battery immersion cooling systems and methods for battery module thermal control and thermal runaway passive prevention.

### Description of Related Art

The demand for alternative, environmentally-friendly sources of powering machines and equipment continues to surge. In particular, demand has grown for machines that rely upon battery systems to provide power for their operation as opposed to more conventional means of power generation, such as through burning of fossil fuels. While the rise in popularity of electric cars and other machines conventionally powered by internal-combustion engines is manifest, many other types of vehicles that already use electric propulsion systems continue to rely upon fossil-fuel powered generators in order to provide the electricity needed for their propulsion and other operational systems. These vehicles include cargo ships, ferries, aircraft, mining equipment, aviation ground service equipment, hyperloop pods, and locomotives. Aside from transportation applications, battery-powered electrical systems can find use in many off-grid applications that presently rely upon either fossil fuel power generation, or less-consistent sources of clean energy, such as solar and wind.

Lithium ion battery cells are presently preferred for many power storage applications. However, safety concerns associated with the use of these cells is well-known and steps must be taken to ensure safe operation of large-scale battery systems employing lithium ion battery cells. One particular operational safety concern associated with lithium ion battery cell usage is thermal energy management. Lithium ion cells tend to release significant quantities of heat during normal cell operation. The generation of this heat needs to be managed, and the system design should account for adequate cooling and/or heat dissipation so that the battery cells can operate efficiently and safely.

Currently, air cooling systems are used to transfer heat away from battery cells. However, there are limits to the amount of heat that can be transferred away from the battery cells in this manner. Thus, heat transfer capability often becomes a limiting feature in the construction of battery modules. In addition, because of the limitations of using air cooling, battery modules must often employ other structures and systems for avoiding propagation of untoward thermal events associated with the battery cells, including the use of thermal barriers and the like. Therefore, there is a need for an efficient battery module cooling system that has a high heat transfer capacity and also provides thermal event propagation mitigation without the need for additional thermal barriers.

### SUMMARY OF THE INVENTION

The present invention is broadly concerned with battery immersion/submersion cooling systems and methods for removing heat from battery cells using a boiling liquid dielectric material.

More particularly, in some embodiments, a battery module comprises: a battery module housing inside of which is contained a plurality of battery cells immersed in a liquid dielectric material contained in a liquid reservoir, the liquid dielectric material having a boiling point under standard atmospheric pressure of less than 75° C., wherein during operation, the plurality of battery cells generating heat energy which is transferred to the liquid dielectric material thereby causing at least a portion of the liquid dielectric material to vaporize, the battery module comprising one or more heat exchange devices configured to remove heat from the vaporized dielectric material thereby causing the dielectric material to condense and be returned to the liquid reservoir. In certain embodiments, the battery module comprises a perforated screen, wherein the screen is horizontally positioned within an upper half of the battery module housing so as to form a head space above the liquid reservoir. In preferred embodiments, the one or more heat exchange devices comprise a heat sink and/or are passive.

In other embodiments, a battery module comprises: a battery module housing inside of which is contained a plurality of battery cells immersed in a liquid dielectric material contained in a liquid reservoir, the liquid dielectric material having a boiling point under one atmosphere of pressure of less than 75° C., wherein during operation, the plurality of battery cells generating heat energy which is transferred to the liquid dielectric material thereby causing at least a portion of the liquid dielectric material to vaporize; and wherein the battery module comprises a pressure control device operable to control the pressure within the battery module housing to which the liquid dielectric material is exposed, the pressure control device comprising a compressor configured to raise or lower the pressure within the housing, the compressor being connected to the housing via a conduit circuit comprising at least one control valve, wherein the at least one control valve is switchable between a first configuration in which the compressor lowers the pressure within the housing and a second configuration in which the compressor increases the pressure in the housing; and wherein the operation of the compressor and the at least one control valve is controlled by a battery management system.

In another embodiment, a method of preventing propagation, flame, or explosion in a battery module is provided. The method comprises selecting a quantity of the liquid dielectric material to be present within the battery module housing based upon the latent heat of vaporization of the liquid dielectric material so that, during a thermal runaway, the quantity of the liquid dielectric material is capable of adsorbing a complete reaction energy of the battery cells.

### BRIEF DESCRIPTION OF THE DRAWINGS

FIG. 1A is a schematic of a battery immersion cooling system arranged as a tank nucleate boiling system according to an embodiment of the present invention;

FIG. 1B is a schematic of a battery immersion cooling system arranged as a thermosiphon circuit according to an embodiment of the present invention;

FIG. 1C is a schematic of a battery immersion cooling system arranged as a forced flow circuit according to an embodiment of the present invention;

FIG. 2A is a schematic side sectional view of a tank nucleate boiling system according to an embodiment of the present invention;

FIG. 2B is a schematic top sectional view of a tank nucleate boiling system according to an embodiment of the present invention;

FIG. 3 is a schematic side sectional view of a battery immersion cooling system arranged as a tank nucleate boiling system according to an embodiment of the present invention.

FIG. 4 is a schematic side sectional view of a tank nucleate boiling system according to an embodiment of the present invention.

FIG. 5A is a schematic side view of a complete rack system according to an embodiment of the present invention; and

FIG. 5B is a schematic side sectional view of a complete rack system according to an embodiment of the present invention.

### DETAILED DESCRIPTION

The present invention is concerned with battery immersion cooling systems and methods for battery module thermal control. The battery immersion cooling systems and methods generally use a liquid dielectric material to transfer heat away from a plurality of battery cells, which is also referred to as a battery module. In preferred embodiments, the battery cells are immersed in the liquid dielectric material, which surrounds and extracts heat from said battery cells by taking advantage of latent heat of vaporization characteristics of the liquid dielectric material.

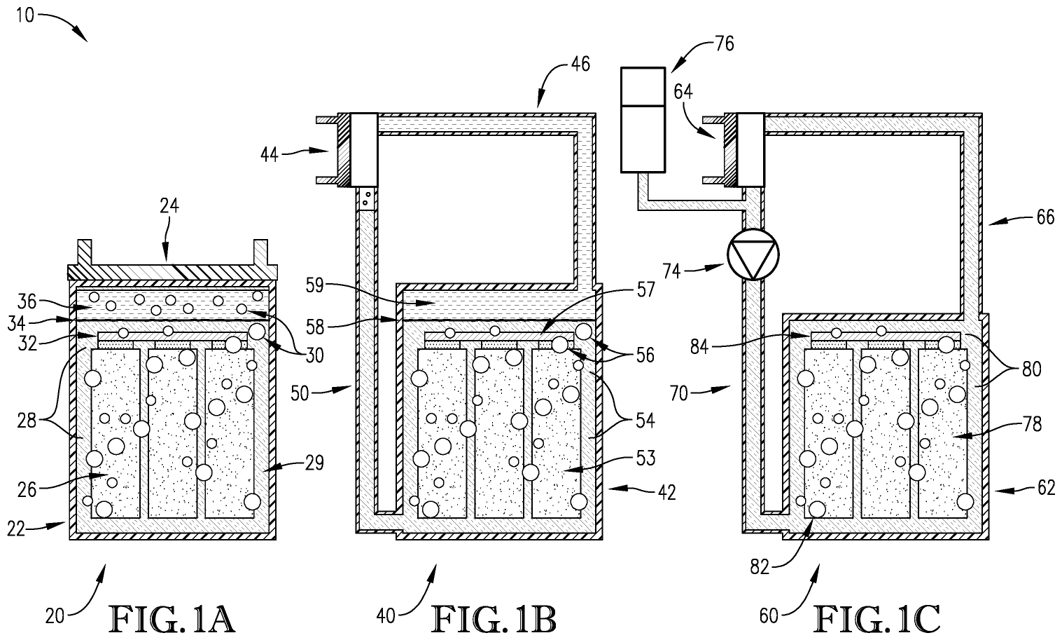

This may be more readily understood with reference to the Figures. FIG. 1 is a schematic diagram of a battery immersion cooling system according to three different embodiments of the present invention. Turning first to FIG. 1A, the battery immersion cooling system 10 is arranged as a tank nucleate boiling system 20. The tank nucleate boiling system 20 generally comprises a battery module housing 22 and a heat sink and/or heat exchanger 24, which may be positioned on the upper surface of the battery module housing 22. The battery module housing 22 generally encloses one or more battery cells 26 and a liquid dielectric material 28. The portion of the housing 22 that contains the cells 26 and the liquid dielectric material 28 is also referred to as a liquid reservoir 29. The one or more battery cells 26 may be oriented within the battery module housing 22 in any manner that is appropriate for the particular configuration of the battery cells. In preferred embodiments, the battery cells 26 are immersed in the liquid dielectric material 28 (i.e., fully surrounded by the liquid dielectric material).

In other embodiments, the battery module housing 22 further comprises one or more current collectors 32 and a perforated screen 34. The one or more current collectors 32, which are attached to an electrode on each battery cell 26, collect electrical current generated at the electrodes and, although not shown in this embodiment, connect with external circuits, such as terminals. In preferred embodiments, a perforated screen 34 may be positioned above the upper half of the battery module housing 22, creating ahead space 36. One of ordinary skill in the art will appreciate that the perforated screen 34 allows gas 30, which is generated by the heat of the one or more battery modules 26, to pass into the head space but stops ejecta, which are common problems in the art, as well as damp tilting phenomena during normal operation. Due to this generation of gas 30, in preferred embodiments, the battery module housing 22 has a large expansion volume (i.e., head space 36) and can withstand high pressure resulting from the generation of vapor from the liquid dielectric material 28.

To cool the battery cells 26, the tank nucleate boiling system 20 facilitates a low-temperature evaporation process using the latent heat of the liquid dielectric material 28 to transfer heat away from the cells 26. As previously discussed, the battery cells 26 are submerged directly into the liquid dielectric material 28, which is initially at room temperature. Once the battery cells 26 generate heat at the temperature needed to raise the temperature of the liquid dielectric material 28 to or near its boiling point (latent heat) and convert the liquid dielectric material 28 to a vapor 30 (sensible heat), the material evaporates, extracting heat away from the battery cells 26. If a perforated screen 34 is used, the generated gas 30 passes through the screen 34 and into the head space 36 above the cells 26 before reaching the heat sink 24. The gas 30 is cooled by the heat sink 24, which provides a surface for condensation of the vapor to occur. After the gas 30 is cooled, the condensate 30 falls back down into the portion of the battery module housing 22 that contains the cells 26. Thus, a cooling cycle is established.

The liquid dielectric material may be any non-conductive fluid capable of removing heat from a battery cell or battery module with high dielectric strength, such as fluorinated fluids. One of ordinary skill in the art would appreciate that a non-conductive fluid with high dielectric strength reduces the need for electrical isolation and allows the fluid to contact battery cells, printed circuit boards, and the like. These properties assist in the prevention of clearance (i.e., shortest distance in the air between two conductive parts)/creepage (i.e., shortest distance to another conductive part along the surface of an insulating material) issues, such as arcing due to closely spaced conductive parts. In preferred embodiments, the liquid dielectric material may also possess other desirable properties, such as being non-corrosive (supports stable and reliable battery performance and reduces maintenance costs), chemically and thermally stable (performs consistently over lifespan of system (about −40° C. to about 85° C.)), non-flammable and non-combustible (helps to increase margin of safety), and/or having a low viscosity (decreases pumping power needed and increases the formation of turbulent flow). The liquid dielectric material has a boiling point range of about 0° C. to about 60° C., preferably about 30° C. to about 50° C. In preferred embodiments, the liquid dielectric material has a boiling point that matches or is close to the desired max operational temperature of the battery cells. The liquid dielectric material also has a 100-year time horizon global warming potential (GWP) of about less than 500, less than 250, less than 100, less than 50, less than 25, less than 10, or less than 1. In some preferred embodiments, the liquid dielectric material is 3M NOVEC 7000 Engineered Fluid (known as methyl perfluoropropyl ether or 1-Methoxyheptafluoropropane). In other preferred embodiments, the liquid dielectric material is 3M NOVEC 649 Engineered Fluid (known as 1,1,1,2,2,4,5,5,5-Nonafluoro-4-(trifluoromethyl)-3-pentanone).

One of ordinary skill in the art would appreciate that the tank nucleate boiling system embodiment is a self-sustaining system, i.e., a system that does not include piping or a pump, and does not facilitate heat transfer using forced convection. In addition, because the system does not use a pump, the tank nucleate boiling system embodiment is a passive system that does not require an input of energy from an external source in terms of recirculation work.

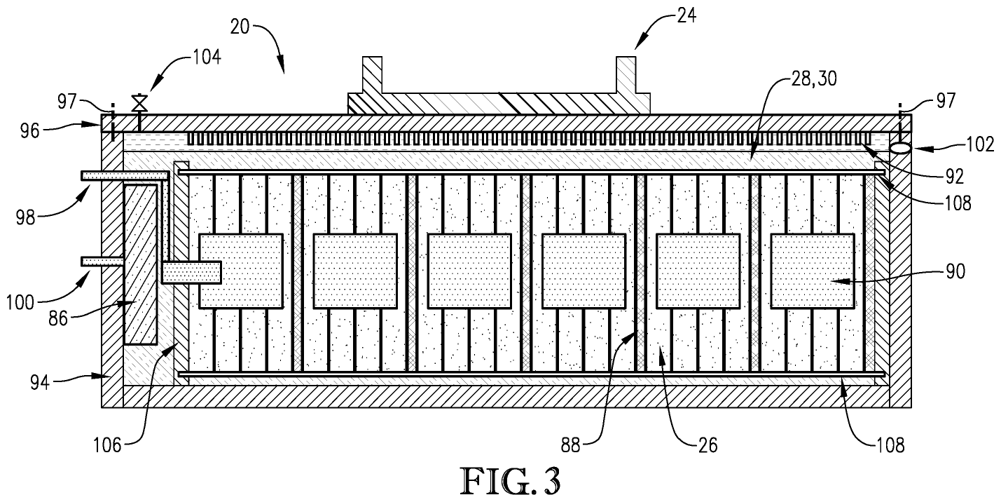

In one or more embodiments, in case of battery cell thermal runaway, the complete battery cell's (or cells') reaction energy may be adsorbed by the latent heat of vaporization of the liquid dielectric material, leading to a complete damping of propagation as well as fire and flame formation. As used herein, the term “thermal runaway” refers to an event in which the temperature inside the battery cell rises suddenly and causes a chain reaction to occur within the cell that releases more heat, which drives further chemical reactions. The gas generated through vaporization of the dielectric fluid is then evacuated from the battery module housing, preferably at the burst disc 102 location (FIG. 3). In preferred embodiments, where a battery module has a number of battery cells (nₚ) electrically connected in parallel, the selection of the liquid dielectric material quantity is performed according to Equation 1:

M>np*(E/he)*S (1)

(where M=liquid dielectric material mass (kg); hₑ=latent heat of vaporization of the liquid dielectric material (J/kg); E=cell reaction energy (J); nₚ=number of electrical parallel battery cells; S=2=safety factor for 200% cell overcharge).

Turning to FIG. 1B, the battery immersion cooling system 10 is arranged as a thermosiphon circuit 40, which is also a passive system. The thermosiphon circuit 40 generally comprises a battery module housing 42, a heat sink and/or heat exchanger 44, a pressure control device (not shown), and at least two conduits 46, 50 interconnecting the heat sink 44 with the battery module housing 42. The battery module housing 42 of the thermosiphon circuit 40 can be similarly constructed as the battery module housing 22 of the tank nucleate boiling system 20 in FIG. 1A (i.e., plurality of battery cells 43, liquid dielectric material 54, gas 56, current collector 57, perforated screen 58, and head space 59). In preferred embodiments, the battery module housing 42 further comprises a perforated screen. However, conduits 46, 50 interconnect housing 42 with the heat sink 44.

To cool the battery cells 53, like the tank nucleate boiling system 20, the thermosiphon circuit 40 facilitates a low-temperature evaporation process using the latent heat of the liquid dielectric material 54 to transfer heat away from the cells 53 through the generation of vapor from the liquid dielectric material 54. However, in the thermosiphon system 40, the vapor 56 is pulled towards the heat sink and/or heat exchanger 44, where the gas 56 condenses and is re-introduced into the battery module housing 42 creating a siphon-like effect. In the depicted embodiment, the vapor 56 travels through one pipe 46, contacts the heat sink 44, condenses, and returns to the battery module housing 42 through a second conduit 50 under the force of gravity.

Though the circuit 40 is sensitive to changes in orientation of the battery module, such as tilting and rolling, one of ordinary skill in the art would appreciate that the thermosiphon circuit 40 does not include a pump nor require an additional expansion tank. In addition, the thermosiphon circuit 40 utilizes low forced convection to facilitate fluid circulation and heat transfer.

Turning to FIG. 1C, the battery immersion cooling system 10 is arranged as a forced flow circuit 60, which relies to a much lesser extent on the use of latent heat (due to limitation of expansion) as compared to the embodiments of FIGS. 1A and 1B. The forced flow circuit 60 generally comprises a battery module housing 62, a heat sink and/or heat exchanger 64, a pressure control device (not shown), conduits 66, 70, and a pump 74. The battery module housing 62 generally encloses one or more battery cells 78 and a liquid dielectric material 80. In preferred embodiments, the battery cells 78 are immersed in the liquid dielectric material 80. In other embodiments, the battery module housing 62 further comprises one or more current collectors 84 or a perforated screen, preferably a perforated screen. In preferred embodiments, the circuit may also comprise an accumulator tank 76, which smooths fluid flow and reduces on/off cycling of the pump 74 by lessening the variation in pressure and flow between the pump 74 and the housing 62 in the forced flow circuit system 60.

To cool the battery cells 78, the forced flow circuit 60 uses the pump to circulate the liquid dielectric material 80, which in turn transfers heat away from the cells 78. Vaporization 82 of the liquid dielectric material 80 generally occurs only in the case of localized overheating of a particular cell 78 (i.e., subcooled nucleate boiling). In these embodiments, the vapor 82 would be conducted away by circulating the liquid dielectric material 80 using the pump 74. The gas 82 contacts the heat sink and/or heat exchanger 64 and re-condenses.

Though the circuit 60 utilizes a pump and pipe, one of ordinary skill in the art would appreciate that the forced flow circuit system 60 can utilize high forced convection as a method to facilitate heat transfer. Because this embodiment uses a pump, it depicts an active system. In addition, there is a strong increase of local heat transfer coefficient (HTC) due to boiling, which leads to more homogeneous temperatures due to “selective” cooling.

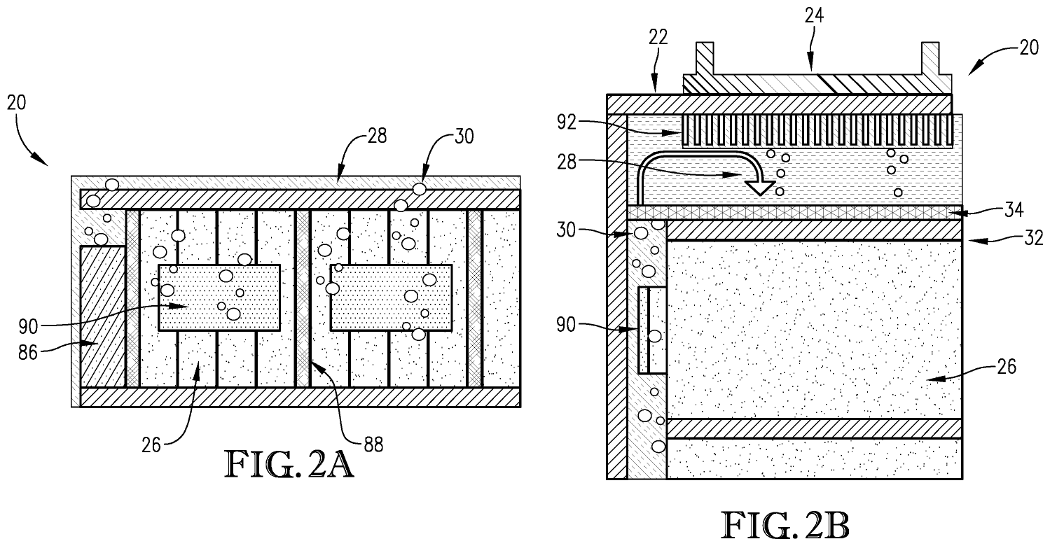

FIGS. 2 and 3 illustrate the tank nucleate boiling system 20 in greater detail. Specifically, FIG. 2A illustrates a schematic side sectional view of the tank nucleate boiling system 20 according to an embodiment of the present invention. In the depicted embodiment, the battery module housing 22 further encloses a module control board (MCB) 86, one or more compression pads 88, and one or more current collectors 90. As shown, the battery cells 26 are immersed directly into the liquid dielectric material 28. The module control board 86 may be positioned anywhere within the battery module housing 22, preferably near one of the ends of the battery module housing 22. As depicted, the one or more compression pads 88, which help hold the battery cells in place, are positioned between a battery module with four battery cells, although this need not always be the case.

FIG. 2B is a schematic top sectional view of the tank nucleate boiling system 20 according to an embodiment of the present invention. In the depicted embodiment, the battery module housing further encloses a plurality of fins 92, which are preferably placed on the top surface of the battery module housing 22. These fins 92 increase the amount of surface area at the top surface of the housing 22, allowing greater heat transfer between the vapor and heat sink.

FIG. 3 is a schematic side sectional view of the tank nucleate boiling system 20 according to an embodiment of the present invention. In the depicted embodiment, the battery module housing 22 may also comprise a module pan 94 and a module cover 96, which may be bolted 97 together to create a tightly sealed housing. For easy access to the terminals 98, 100, the module pan 94 may contain two or more holes, as shown. For safety purposes, a burst disc 102 may be disposed within the module pan 94 of the battery module housing 22, and a decompression valve 104 may also be disposed within the module cover 96 of the battery module housing 22. The battery module housing 22 may also further enclose one or more compression plates 106 and one or more rods 108 positioned in a manner to hold the battery cells 26 in place. If a rod is used, the rod 108 may be positioned on the upper surface of the one or more battery modules 26 to prevent the cells 26 from shifting within the battery module housing 22. If a second rod 108 is used, that rod may be positioned on the bottom surface of the one or more battery modules 26.

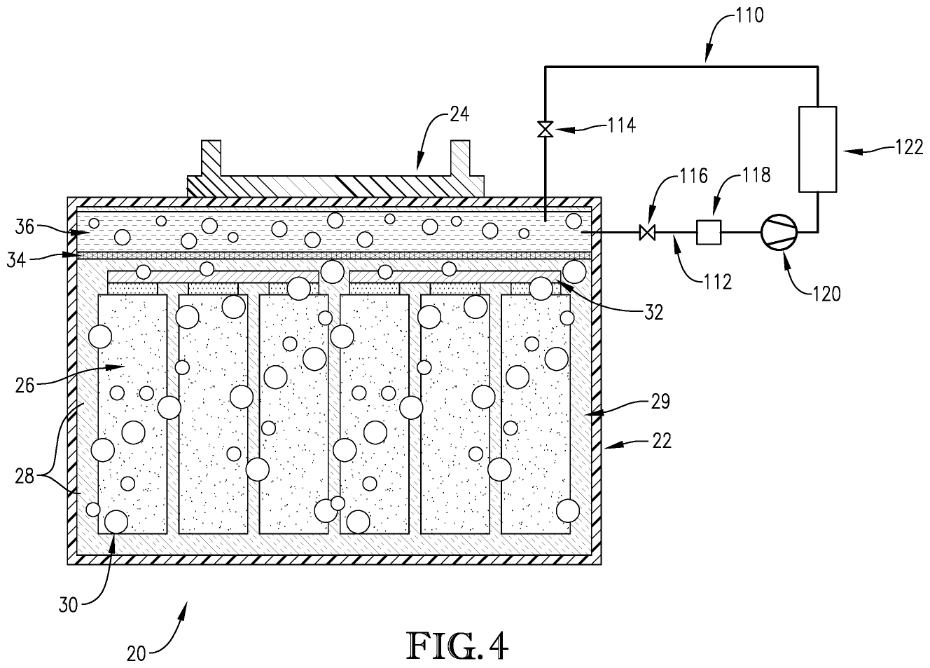

FIG. 4 is a schematic side sectional view of a tank nucleate boiling system according to an embodiment of the present invention. In the depicted embodiment, the tank nucleate boiling system 20 further comprises conduits 110, 112, shut-off valves 114, 116, a filter 118, a pressure control device (not shown), an electrical compressor 120, and a tank/gas reservoir 122. The battery module housing 22 generally encloses one or more battery cells 26 and a liquid dielectric material 28, which preferably has low a GWP and/or a boiling point range of from about 40° C. to 50° C. (e.g., 3M NOVEC 649, Solvay Galden PFPE, or Opteon SF10).

To cool the battery cells 26, the depicted embodiment of the tank nucleate system 20 controls the pressure within head space 36 to adjust the boiling point of the liquid dielectric material 28. By controlling the temperature at which the liquid dielectric material 28 vaporizes, the rate of heat transfer from cells 26 can be controlled. For example, in a preferred embodiment, the pressure control device may be used to control the pressure within the battery module housing 22. In other preferred embodiments, the pressure control device may comprise the electrical compressor 120, which also may be used to reduce pressure within the battery module housing 22 (i.e., pull a vacuum). This reduction in pressure causes the liquid dielectric material to boil at a lower temperature. Thus, heat transfer away from cells 26 (via latent heat transfer) can be affected at a lower temperature. Alternatively, compressor 120 can be used to increase the pressure within head space 36, thereby causing the dielectric material 28 to vaporize at a higher temperature. A battery management system (not shown) can be used to control the operation of compressor 120 and valves 114, 116 depending upon the particular needs of system 20.

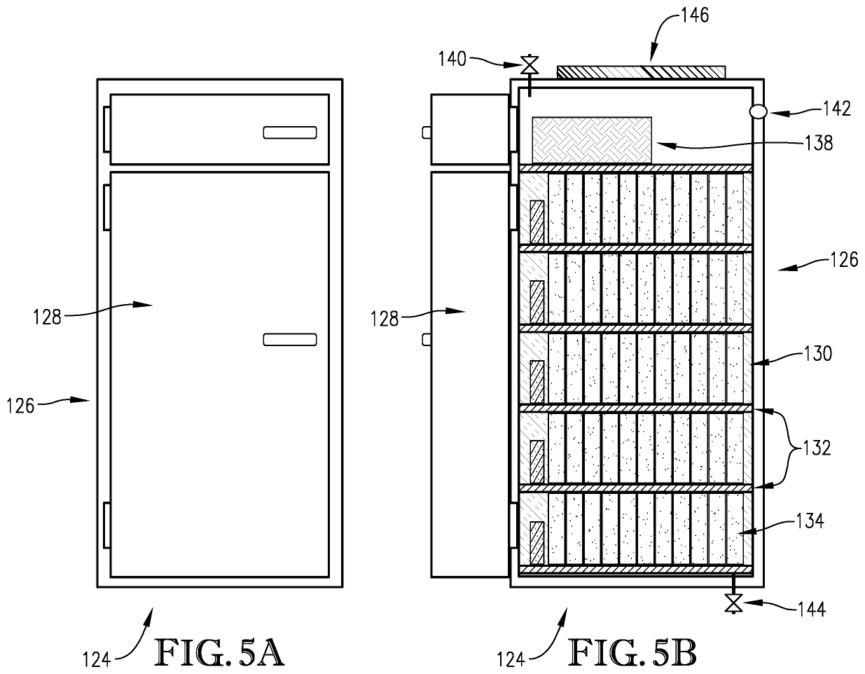

FIG. 5 illustrates a battery immersion cooling system according to a complete rack embodiment of the present invention. Turning to FIGS. 5A and 5B, the complete rack system 124 comprises a cabinet 126 and a tightly sealed door 128, which prevents any liquid dielectric material 130 from leaking out of the system 124. Turning to FIG. 5B, the cabinet 126 preferably contains one or more racks 132, which can store one or more battery modules 134 and optionally a module control board 136 and/or a string control board (SCB) 138. In the depicted embodiment, a battery module 134 may be stored on each rack 132, although this need not always be the case. Like the single module embodiments, the battery cells 134 are submerged in liquid dielectric material 130. The cabinet 126 may further comprise a filling valve 140, a burst disc 142, and a bleeding valve 144. A heat sink and/or heat exchanger 146 can be positioned on the top surface of the cabinet 126.

To cool the battery cells 134, the complete rack system 124 facilitates a low-temperature evaporation process like the single module embodiments.

Additional advantages of the various embodiments of the invention will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments, but is not necessarily included. Thus, the present invention encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

As used herein, the term “battery module” refers to a collection of two or more battery cells. The battery cells within the battery module may be connected in series, in parallel, or there may be cells connected in series and cells connected in parallel within the same module.

As used herein, the term “battery cell” refers to an electrochemical cell that can generate electrical energy from a chemical reaction. The battery cell may be an electrolytic cell in which a cathode and anode are separated by an electrolyte. An exemplary battery cell for use with the present invention is a lithium ion battery cell. There are many types of electrolytes that may be used in lithium ion battery cells including, but not limited to mixtures of organic carbonates such as ethylene carbonate or diethyl carbonate containing complexes of lithium ions. These non-aqueous electrolytes generally use non-coordinating anion salts such as lithium hexafluorophosphate (LiPF₆), lithium hexafluoroarsenate monohydrate (LiAsF₆), lithium perchlorate (LiClO₄), lithium tetrafluoroborate (LiBF₄), and lithium triflate (LiCF₃SO₃). It is noted that many concepts of the present invention described herein can also be applicable to other electrochemical devices and energy storage devices besides those based upon battery cells, including lithium ion capacitors and supercapacitors. For expediency purposes, all such non-battery devices are encompassed by the term “battery cell” as used herein.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

1. A battery module comprising:
a battery module housing inside of which is contained a plurality of battery cells immersed in a liquid dielectric material contained in a liquid reservoir, the liquid dielectric material having a boiling point at 1 atmosphere of pressure of less than 75° C.,
wherein during operation, the plurality of battery cells generating heat energy which is transferred to the liquid dielectric material thereby causing at least a portion of the liquid dielectric material to vaporize,
the battery module comprising one or more heat exchange devices configured to remove heat from the vaporized dielectric material thereby causing the dielectric material to condense and be returned to the liquid reservoir.

2. The battery module of claim 1, wherein the one or more heat exchange devices comprises a heat sink equipped with a plurality of fins configured to contact the vaporized dielectric material.

3. The battery module of claim 1, wherein the battery module comprises a perforated screen, wherein the screen is horizontally positioned within an upper half of the battery module housing thereby forming a head space above the liquid reservoir.

4. The battery module of claim 1, wherein the liquid dielectric material is an inert, non-conductive fluid having a dielectric constant of no more than 25.

5. The battery module of claim 1, wherein the liquid dielectric material comprises a fluorinated alkyl ether.

6. The battery module of claim 5, wherein the fluorinated alkyl ether is methyl perfluoropropyl ether.

7. The battery module of claim 1, wherein the liquid dielectric material is provided in an amount capable of adsorbing a complete reaction energy of the battery cells during a thermal runaway.

8. The battery module of claim 1, wherein the one or more heat exchange devices are passive cooling devices.

9. The battery module of claim 1, wherein the one or more heat exchange devices comprises a pump configured to circulate the liquid dielectric material within the liquid reservoir.

10. The battery module of claim 1, wherein the battery module housing further comprises a cabinet having one or more racks configured to receive the plurality of battery cells.

11. The battery module of claim 1, wherein the battery module comprises at least one conduit interconnecting the housing with the one or more heat exchange devices and through which vaporized dielectric material released from the liquid reservoir is directed, the battery module comprising at least one other conduit configured to direct condensed dielectric material from the one or more heat exchange devices to the liquid reservoir.

12. The battery module of claim 1, wherein the battery module comprises a pressure control device operable to control the pressure within the battery module housing to which the liquid dielectric material is exposed.

13. The battery module of claim 12, wherein the pressure control device comprises a compressor configured to raise or lower the pressure within the housing, the compressor being connected to the housing via a conduit circuit comprising at least one control valve, wherein the at least one control valve is switchable between a first configuration in which the compressor lowers the pressure within the housing and a second configuration in which the compressor increases the pressure in the housing.

14. The battery module of claim 13, wherein the operation of the compressor and the at least one control valve is controlled by a battery management system.

15. A battery module comprising:
a battery module housing inside of which is contained a plurality of battery cells immersed in a liquid dielectric material contained in a liquid reservoir, the liquid dielectric material having a boiling point under one atmosphere of pressure of less than 75° C.,
wherein during operation, the plurality of battery cells generating heat energy which is transferred to the liquid dielectric material thereby causing at least a portion of the liquid dielectric material to vaporize; and
wherein the battery module comprises a pressure control device operable to control the pressure within the battery module housing to which the liquid dielectric material is exposed, the pressure control device comprising a compressor configured to raise or lower the pressure within the housing, the compressor being connected to the housing via a conduit circuit comprising at least one control valve,
wherein the at least one control valve is switchable between a first configuration in which the compressor lowers the pressure within the housing and a second configuration in which the compressor increases the pressure in the housing; and
wherein the operation of the compressor and the at least one control valve is controlled by a battery management system.

16. A method of preventing propagation, flame, or explosion in a battery module according to claim 1, the method comprising selecting a quantity of the liquid dielectric material to be present within the battery module housing based upon the latent heat of vaporization of the liquid dielectric material so that, during a thermal runaway, the quantity of the liquid dielectric material is capable of adsorbing a complete reaction energy of the battery cells.

17. The method of claim 16, wherein the plurality of battery cells is electrically connected in parallel.
